(19) United States
(12) Patent Application Publication
(10) Pub. No.: US 2025/0069029 A1
(43) Pub. Date: Feb. 27, 2025

(54) PREDICTING PACKAGE DISTRIBUTION NETWORK ATTRIBUTES

(71) Applicant: Inxeption Corporation, South San Francisco, CA (US)

(72) Inventors: Mark Moore, Burlingame, CA (US); Dat Doan, South San Francisco, CA (US); Marc Verbeek, South San Francisco, CA (US); Jacob Throgmorton, South San Francisco, CA (US); John Spenlau, South San Francisco, CA (US)

(21) Appl. No.: 18/453,562

(22) Filed: Aug. 22, 2023

(51) Int. Cl. G06Q 10/083

(52) U.S. Cl. CPC G06Q 10/0838

(57) ABSTRACT

Techniques are described herein for predicting package distribution network attributes. A model of a package distribution network may be initialized in a digital computing system. The model may be a graph with nodes representing intermediate waypoints and edges representing distribution channels between intermediate waypoints. Some edges may include initial values of attribute(s) of the respective distribution channels of the package distribution network. Using the model, traversal of package(s) may be simulated through candidate pathways across the package distribution network. This may include applying data indicative of nodes and edges (including the initial values) of the graph as input across machine learning model(s) to generate predicted values of attribute(s) of the package distribution network. Metric(s) associated with each of the candidate pathways across the package distribution network may be determined and used to select candidate pathway(s) across the package distribution network for use in one or more downstream computing processes.

### BACKGROUND

A package distribution network may include distribution facilities such as container ports, railyards, airports, intermediate warehouses, etc., as well as “lanes” between these locations. Lanes may include, for instance, shipping lanes across bodies of water, rivers, rail lines, roads, highways, predetermined flight routes, etc. Given the myriad distribution facilities and lanes that exist, there may be innumerable ways to procure and/or route a package from one or more origins/sources to one or more destinations, some more efficient and/or less risky than others.

The efficiency and/or riskiness of aspects of package distribution networks may be affected by various exogenous factors. Lanes may be affected by mild and/or extreme weather, conflict, labor disputes, which may result in congestion and/or underuse, changes in how quickly vehicles can pass through, etc. Distribution facilities can also be affected by various exogeneous factors. For example, distribution facilities can become congested when there is more freight to process than the distribution facility has capacity for, when the distribution facility lacks sufficient personnel, etc.

### SUMMARY

Implementations are described herein for using machine learning and/or artificial intelligence to predict attributes of distribution channels (e.g., distribution facilities, lanes) and/or waypoints of a package distribution network, and for facilitating safe and/or efficient routing of packages across the package distribution network based on these predicted attributes. More particularly, but not exclusively, implementations are described herein for leveraging machine learning and/or artificial intelligence to simulate traversal of packages through multiple candidate pathways across the package distribution network. Based on the simulation, multiple candidate pathways can be evaluated for efficiency, safety, and/or one or more other metrics.

In some implementations, a method may be implemented by one or more processors and may include: initializing a model of a package distribution network in the digital computing system, the model comprising a graph with nodes representing intermediate waypoints of the package distribution network and edges representing distribution channels between the intermediate waypoints, wherein at least some of the edges include initial values of one or more attributes of the respective distribution channels of the package distribution network; using the model, simulating traversal of one or more packages through a plurality of candidate pathways across the package distribution network, wherein the simulating comprises applying data indicative of nodes and edges of the graph as input across one or more machine learning models to generate predicted values of one or more attributes of the distribution channels of the package distribution network, wherein the data indicative of nodes and edges includes the initial values; based on the simulating, determining at least one metric associated with each of the candidate pathways across the package distribution network; and based on the metrics, selecting one or more of the candidate pathways across the package distribution network for use in one or more downstream computing processes.

In various implementations, the one or more downstream computing processes may be configured to cause output indicative of the one or more selected candidate pathways to be rendered at one or more output devices. In various implementations, the method may further include: determining, based on user input received at the digital computing system or another digital computing system, that a given candidate pathway has been selected; identifying a distribution entity that facilitates usage of the given candidate pathway; and automatically generating and transmitting, to the identified distribution entity, a digital message comprising a directive to distribute the one or more packages through at least a portion of the given candidate pathway.

In various implementations, the method may further include ranking the plurality of candidate pathways based on the metrics. In various implementations, the predicted values of one or more attributes of the distribution channels may include a capacity of one of the distribution channels. In various implementations, the predicted values of one or more attributes of the distribution channels may include a risk of payload loss or damage associated with one of the distribution channels.

In various implementations, the initial values may include a capacity of one of the distribution channels of the package distribution network. In various implementations, the machine learning model may take the form of a transformer model, and the method may further include, prior to the applying, linearizing at least a portion of the graph into a sequence of tokens representing nodes and edges of the graphs. In other implementations, the machine learning model may include a graph neural network.

In various implementations, the metric associated with each candidate pathway may include a predicted time interval to traverse the one or more packages through the candidate pathway. In various implementations, the metric associated with each candidate pathway may include a predicted risk of loss of the one or more packages in transit. In various implementations, one or more of the machine learning models may have been trained based on historical distribution data to generate output indicative of predicted distribution channel attributes.

In another related aspect, a method may be implemented using a digital computing system, and may include: initializing a model of a package distribution network in the digital computing system, the model comprising a graph with nodes connected by edges, wherein at least some of the nodes or edges include initial values of one or more attributes of distribution channels of the package distribution network; using the model, identifying a plurality of candidate pathways for sending one or more payloads across the package distribution network; encoding the graph, including the initial values, into a reduced-dimensionality graph embedding using one or more first machine learning models; applying the reduced-dimensionality graph embedding as input across one or more second machine learning models to generate a probability distribution over the plurality of candidate pathways; and based on the probability distribution, selecting one or more of the candidate pathways across the package distribution network for use in one or more downstream computing processes.

In various implementations, each probability of the probability distribution may represent a probability that traversal of one or more of the payloads across a respective distribution channel will satisfy a constraint. In various implementations, the constraint may include a temporal constraint. In various implementations, the constraint may include a risk of payload loss.

In various implementations, the one or more downstream computing processes may include a computing process for selecting one or more distribution channels between an origin and a destination. In various implementations, the nodes may represent waypoints of the package distribution network and edges represent distribution channels between the waypoints. In various implementations, the edges may represent waypoints of the package distribution network and the nodes represent distribution channels between the waypoints.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be implemented, in accordance with various implementations.

FIG. 2 schematically depicts an example of a graph that may be used to represent a portion of a real-world package distribution network, in accordance with various implementations.

FIG. 3A and FIG. 3B depict examples of how data indicative of a package distribution network may be processed in order to make various predictions.

FIG. 4 depicts another example of a graph that may be used to represent a portion of a real-world package distribution network, in accordance with various implementations.

FIG. 5 depicts a flowchart illustrating an example method for practicing selected aspects of the present disclosure.

FIG. 6 depicts a flowchart illustrating another example method for practicing selected aspects of the present disclosure.

FIG. 7 illustrates an example architecture of a computing device.

### DETAILED DESCRIPTION

Implementations are described herein for using machine learning and/or artificial intelligence to predict attributes of distribution channels (e.g., distribution facilities, lanes) and/or waypoints of a package distribution network, and for facilitating safe and/or efficient routing of packages across the package distribution network based on these predicted attributes. More particularly, but not exclusively, implementations are described herein for leveraging machine learning and/or artificial intelligence to simulate traversal of packages through multiple candidate pathways across the package distribution network. Based on the simulation, multiple candidate pathways can be evaluated for efficiency, safety, and/or one or more other metrics.

In various implementations, a digital model of a package distribution network may be initialized in memory of a digital computing system. The model may include a directed or undirected graph with nodes connected by edges. The graph may represent and/or simulate the package distribution network. Nodes and/or edges of the graph may include a variety of static and/or dynamic attributes that can be populated with values representing real-world conditions of the package distribution network at any given moment. Dynamic attributes may include, for instance, capacity, congestion, a risk of payload loss or damage, a latency, transit time, or delay associated with a node or edge, resources required to handle a package, weather impacting a node or edge, road conditions (e.g., how many lanes open), and so forth. Static attributes may include, for instance, geographic distance. Thus, the graph may represent, at any given moment in time, a state or “snapshot” of the package distribution network.

In some implementations, the nodes represent intermediate stops (e.g., waypoints) of the package distribution network and edges represent distribution channels between the waypoints. For example, waypoints may correspond to distribution facilities such as container ports, railyards, airports, or other intermediate stops, and distribution channels may correspond to lanes between distribution facilities. In other implementations, the edges represent simple waypoints between distribution channels of the package distribution network, and the nodes represent the distribution channels themselves, including both distribution facilities and the lanes between them. In some implementations, there may be multiple different distribution channels or lanes between locations. For example, there may be multiple different carriers that are equipped to transport packages across a given lane or distribution channel. Each carrier may have its own attributes, strengths, costs, etc., that may be represented as attributes of the real-world package distribution network.

In various implementations, the digital model may be used to simulate traversal of one or more physical packages, such as equipment, tools, chemicals, machinery, components, ingredients, parts, etc., through one or more candidate pathways across the package distribution network. Each of these candidate pathways across the package distribution network may be represented by respective node(s) and edge(s) of the model's graph. Based on the simulation, one or more of the candidate pathways may be identified and/or selected, e.g., automatically or manually by a user, to efficiently and/or safely route a package across the package distribution network.

In some implementations, the simulation based on the digital model may include applying data indicative of nodes and edges of the graph as input across one or more machine learning models to generate output. The output may be indicative of, for instance, predicted values of one or more attributes of the package distribution network, metrics associated with individual candidate pathways, probability distributions over multiple candidate pathways and/or constituent pathway components (e.g., individual lanes and/or waypoints), and so forth.

The input data that is processed using machine learning may include initial values of attribute(s) of the package distribution network. These initial values may include, for instance, congestion/traffic volumes across various shipping lanes, delays of various shipping lanes or distribution facilities (e.g., caused by congestion or exogenous factors such as construction, weather, conflict, labor disputes, etc.), and/or any other attribute of the package distribution network that can influence a package's journey. These input data may be current values (e.g., directly or indirectly observed), hypothetical, and/or predicted or expected. For example, if volumes of packages being shipped across two different shipping lanes to a single distribution facility (e.g., a warehouse) are known, then the warehouse's expected capacity may be predicted based on the combined package volumes, existing warehouse inventory, and planned outgoing inventory.

In implementations in which the output generated based on the machine learning includes predicted attribute values, the predicted attribute values may take various forms, including forms similar to the input values. For example, the predicted attribute values of the package distribution network that are generated during the simulation may include predicted congestion or traffic volume of a shipping lane (which may impact latency or risk of package loss), predicted delays associated with shipping lanes or distribution facilities, predicted risk(s) of payload loss (e.g., total loss, damage, etc.), and so forth.

In some implementations, the predicted attribute values of the package distribution network may be used to calculate and/or assign metric(s) or score(s) to candidate pathways across the package distribution network. The metric(s) or score(s) may represent, for instance, a time interval projected for package(s) to traverse between two or more waypoints and/or arrive at a destination, a risk or probability the package(s) will be lost and/or damaged in transit, and/or amounts of resources (e.g., expense) required to traverse between two or more waypoints and/or utilize an entire candidate pathway. In some cases, a composite or aggregate metric or score may be calculated for an entire candidate pathway based on two or more constituent metrics associated with, for instance, individual lanes, waypoints, distribution channels, etc.

These metrics or scores may be used for various purposes. In some implementations they may be used to select one or more of the candidate pathways across the package distribution network for use in one or more downstream computing processes. One example of such a downstream computing process is a computing process for selecting, automatically or manually by a user wishing to route a package across the package distribution network, one of the candidate pathways across the package distribution network. Another example of a downstream computing process is a process by which a carrier is identified that can make use of the selected candidate pathway(s). A digital message (e.g., email, push notification, digital purchase order) containing a directive to distribute the one or more packages through at least a portion of the selected candidate pathway(s) may be automatically generated and/or transmitted to the identified carrier.

In a process that is sometimes referred to herein as “tokenization,” various types of machine learning models may be trained and applied to data indicative of graphs representing package distribution networks, e.g., to generate semantically rich embeddings (e.g., continuous or discrete vector embeddings) representing all or parts of graphs representing package distribution networks. In some implementations, graph neural networks (GNNs) may be employed. GNNs are machine learning models that encode both node values/attributes and relationships between nodes using iterative message passage/propagation between neighbors. GNNs may take various forms, including but not limited to a graph convolutional network (GCN), a graph attention network (GAT), and/or an edge-enhanced graph neural network (EGNN), to name a few.

Additionally or alternatively, graph data representing the package distribution network can be preprocessed (e.g., tokenized) into other forms that can be processed by other types of machine learning models that are designed to operate on non-graph data. For example, graph data can be linearized into a sequence of tokens representing the nodes and edges. This sequence of tokens can then be processed by a sequence-to-sequence model, such as various types of recurrent neural networks (e.g., LSTM, GRU), transformer networks (also referred to as “generative networks” or “generative transformers”; e.g., similar to those sometimes used as large language models, or “LLMs”), etc., to generate output in the form of, for instance, a new sequence of tokens, one or more semantically rich embeddings representing the entire graph, etc.

Semantically rich embeddings (or more generally, tokens) generated using these various techniques may be used in various ways. In some implementations in which GNNs are employed, embeddings representing individual nodes and/or edges may be enriched with information iteratively propagated from neighbors. Consequently, the individual node embeddings may be processed using various techniques, such as one or more additional neural layers, decoding layers, etc., to predict and/or estimate various attributes (e.g., congestion, capacity, traffic volume, latency) of the package distribution network's distribution facilities and/or shipping lanes.

For instance, backbone network(s) (e.g., various types of GNNs, other types of neural networks) may be used to extract features from the nodes and edges of the graph representing the package distribution network, and to generate semantically rich embedding(s). These semantically rich embeddings, which may represent individual nodes, edges, or the entire graph, may then be applied as inputs across one or more prediction machine learning models or processes to make various estimations and/or predictions. In some implementations, these prediction machine learning models may include one or more prediction heads. Each prediction head may be trained to generate, based on the input embedding, a different prediction about a lane or distribution facility of the package distribution network, such as capacity, traffic volume, risk of payload loss, amount of resources required by a lane/facility, etc.

In some implementations, the downstream model(s) for processing the semantically rich embeddings may generate probability distributions over discrete and/or continuous search space(s). For example, a discrete search space may be defined as a plurality of candidate pathways across the package distribution network that can be used to route a particular package (or type of package in the case of a fungible good) from one or more origins to one or more destinations. To limit the discrete search space, in some implementations, the candidate pathways may be limited to those having less than some threshold number of hops, or those representing less than some threshold total geographic distance. For example, it would be inefficient (and possibly risky) to route a package through too many distribution facilities, or to route the package around the entire planet to a destination that is geographically proximate to the origin. Other candidate pathways may not be considered and/or may be assigned zero or null values.

In addition to or instead of predicting attribute values of the package distribution network or probability distributions, the semantically rich embeddings may be compared to reference embeddings generated based on historical states of the package distribution network (or relevant portions thereof). This comparison may include determining similarity measures between embeddings using techniques such as cosine similarity, dot product, Euclidean distance, etc. To this end, the embedding machine learning models used to generate the embeddings may be trained using similarity learning techniques such as triplet loss.

In some implementations, training data for an embedding machine learning model may include training tuples. Each training tuple may include: (i) a state or snapshot (e.g., a semantically rich embedding generated as described previously) of the graph representing the package distribution network; and (ii) a representation (e.g., subgraph, additional embedding) representing a pathway used contemporaneously with the state/snapshot to route a package across the package distribution network. In some cases, the tuple may also include a label indicative of the shipment's outcome, such as “success,” “failure,” a grade or rating of the shipment, a measure of profitability, etc. These tuples may be processed, e.g., using an encoder machine learning model, or by combining the snapshot and pathway embeddings (e.g., using summation, concatenation, etc.), to generate embeddings in embedding space. In some implementations, the embedding space may be indexed by the labels.

When a user wishes to order a new package for delivery to a destination, the current state/snapshot of the graph representing the package distribution network may be obtained, e.g., as a semantically rich embedding. Some number of candidate pathways through the package distribution network that will effectuate the desired shipment may also be defined, e.g., as described above (e.g., limited to less than x hops). Some number of pairs, each including the graph state/snapshot and a respective individual candidate pathway, may be encoded to generate semantically rich embeddings. These may then be compared to reference embeddings to identify similar historical scenarios in which packages were sent under similar contexts. Then, one or more of the reference embeddings that include a positive outcome may be used (e.g., to cross reference or be decoded) as an indication of a “best” or “suitable” candidate pathway that the user can or should use to route the package across the package distribution network.

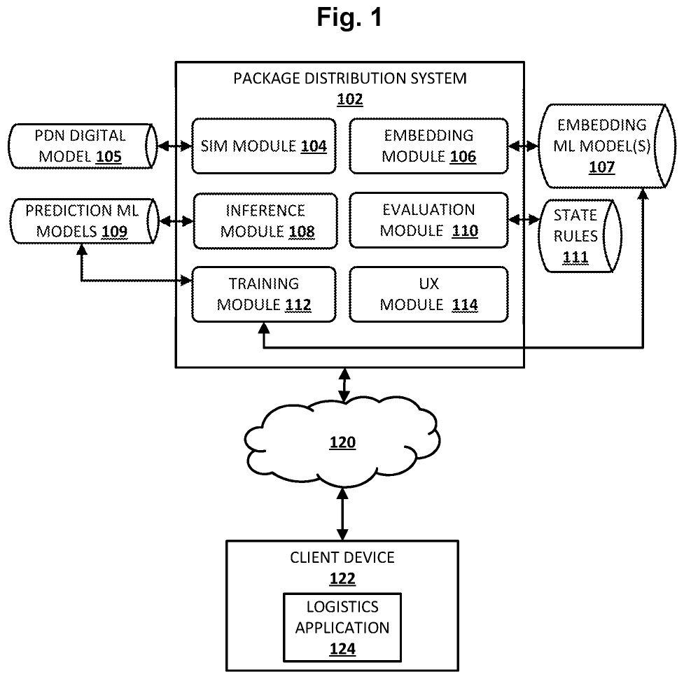

FIG. 1 schematically depicts an example environment in which selected aspects of the present disclosure may be implemented, in accordance with various implementations. Any computing devices depicted in FIG. 1 or elsewhere in the figures may include logic such as one or more microprocessors (e.g., central processing units or “CPUs”, graphical processing units or “GPUs”, tensor processing units or “TPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as a package distribution system 102, may be implemented using one or more server computing devices that form what is sometimes referred to as a “cloud infrastructure,” although this is not required.

Package distribution system 102 may include a variety of different modules that may be implemented using any combination of hardware and software to perform selected aspects of the present disclosure. In FIG. 1, package distribution system 102 includes a simulation (SIM) module 104, an embedding module 106, an inference module 108, an evaluation module 110, a training module 112, and/or a user interface (UX) module 114. In other implementations, one or more of modules 102, 104, 106, 108, 110, 112, and/or 114 may be combined with other(s) of modules 102, 104, 106, 108, 110, 112, omitted, implemented elsewhere (e.g., wholly or partially on a client device 122), etc.

An individual (which in the current context may also be referred to as a “user”) may operate a client device 122 to interact with other components depicted in FIG. 1. Each client device 122 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) that provides an AR or VR immersive computing experience, a “smart” watch, and so forth. Additional and/or alternative client devices may be provided.

Client device 122 may be operably/communicatively coupled with package distribution system 102 via one or more local area and/or wide area networks 120, such as the Internet. In some implementations, client device 122 operates a logistics application 124 that a user may control to perform and/or take advantage of selected aspects of the present disclosure by interacting with package distribution system 102. In some implementations, logistics application 124 may be a standalone computer application. Additionally or alternatively, in some implementations, logistics application 124 may be provided as an interactive web page that can be accessed using another computer application, such as a web browser. In either case, logistics application 124 may allow a user to interact with package distribution system 102 to be presented with various observed and/or predicted attributes of a real-world package distribution system (not depicted) for which package distribution system 102 provides logistical and/or consulting services. The user may use these data to make decisions, or the decisions may be made automatically, about how best to transport packages between locations in the real-world package distribution network.

SIM module 104 may be configured to process data indicative of the real-world package distribution network to initialize and/or maintain a package distribution network (PDN) digital model 105 in one or more databases of one or more digital computing systems, such as package distribution system 102. In some implementations, PDN digital model 105 may take the form of a “digital twin” that is configured to simulate real time or near real time conditions of the real-world package distribution network. For example, the digital twin may include real time or near real time observed attributes of the various lanes/distribution channels, waypoints, or other components of the real-world package distribution network.

In various implementations, PDN digital model 105 may be periodically and/or continuously updated, e.g., by SIM module 104, to include real time attributes of lanes such as capacity, measures of traffic, risk of package loss, latency (e.g., time to traverse a lane), congestion, and so forth. As noted previously, lanes and distribution channels are not limited to roads, waterways, airspace, etc. In many implementations, lanes and distribution channels may represent particular entities, such as particular carriers of packages. Thus, for instance, there may be multiple lanes between a given pair of waypoints where there are multiple different carriers (e.g., competitors) equipped to transport packages between the waypoints. Each carrier may have its own operational capabilities (e.g., capacity to carry more packages, risk of loss, fuel costs/efficiency, carbon footprint, capability of travelling in inclement weather such as snow, etc.) that may be presented as attributes of lanes/distribution channels, similar to other types of lanes/distribution channels.

In some implementations, the real time attributes of lanes maintained as part of PDN digital model 105 may include exogeneous factors that may impact transport of a package across the real-world package distribution network. These may include, but are not limited to, localized weather and/or climate conditions (e.g., choppy seas, headwinds and/or tailwinds, precipitation), political upheaval (e.g., labor strikes), conflict(s), construction, and/or natural disasters, to name a few.

In various implementations, PDN digital model 105 may include a directed or undirected graph. In some implementations, the graph may include nodes representing, for instance, intermediate waypoints of the real-world package distribution network. Edges may represent, for instance, distribution channels (or “lanes”) between the intermediate waypoints. In some implementations, waypoints may include and/or represent ingress and egress points of distribution centers (e.g., container ports, airports, truck hubs, railyards, etc.), as well as starting and ending points (e.g., first and second shipping container ports) of lanes (e.g., the body of water in between the first and second shipping container ports). In other implementations in which nodes have assignable attributes but edges do not, the edges may represent waypoints of the package distribution network and the nodes themselves may represent distribution channels between the waypoints.

As part of the tokenization process, embedding module 106 may be configured to process/preprocess various data, such as user-provided input(s) indicating one or more origins/sources, and one or more destinations of packages to be transported, as well as data indicative of PDN digital model 105, so that the data can be processed to make predictions as described herein. As its name suggests, in some implementations, embedding module 106 may be configured to generate semantically rich embeddings that represent the state of all or parts of PDN digital model 105. In various implementations, the embeddings generated by embedding module 106 may be discrete or continuous, and may have any number of dimensions. In some implementations, embedding module 106 may employ one or more embedding machine learning (ML) models 107 to generate embeddings. Examples of such models will be described in more detail below.

Inference module 108 may be configured to process various data using various types of prediction ML models 109 to generate various inferences and/or predictions, e.g., about attributes of the real word package distribution network currently and/or in the future. These inferences and/or predictions may be used for a variety of downstream computer processes that can ultimately facilitate efficient, dependable, and/or timely delivery of packages across the real-world package distribution network.

In some implementations, models 107 and/or models 109 may include sequence-to-sequence models such as auto-encoders and/or large language models such as Bidirectional Encoder Representations from Transformers (BERT) transformers and/or generative pre-trained transformers (GPT, GPT-2, GPT-3, GPT-4, etc.). Additionally or alternatively, in some implementations, models 107/109 (particularly 107) may be configured to operate on graph input, such as graphs used as part of PDN digital model 105. These graph-based models may include, for instance, a graph neural network (“GNN”), a graph attention neural network (“GANN”), and/or graph convolutional neural network (“GCN”), to name a few. Models 107 and/or 109 may take other forms as well, such as various flavors of a recurrent neural network (RNN, LSTM, GRU, etc.), and any other type of machine learning model that may be applied to facilitate selected aspects of the present disclosure.

Evaluation module 110 may be configured to evaluate various aspects of PDN digital model 105 and/or predictions generated by inference module 108 to facilitate various downstream computer processes. For example, evaluation module 110 may be configured to evaluate one or more candidate pathways across the package distribution network for delivering package(s) from origins(s) to destination(s). This evaluation may include, for instance, assigning various of the aforementioned metrics to the candidate pathways and/or constituent components thereof, such as individual lanes, distribution channels, etc. In some implementations, evaluation module 110 may apply one or more state rules 111 to heuristically eliminate and/or promote/demote/rank particular candidate pathways or constituent parts thereof. For example, if a particular distribution channel such as a rail line is temporarily unavailable, e.g., due to track repairs, that distribution channel may be excluded from consideration for the duration of the repairs.

Training module 112 may be configured to, alone or in combination with inference module 108, train, tune, and/or fine-tune various ML models 107/109 described herein based on a variety of different types of training data, e.g., using techniques such as gradient descent, back propagation, cross entropy, etc. Depending on the type of model being trained, the availability of training data, and/or other context, training module 112 may perform supervised training, semi-supervised training, unsupervised training, reinforcement learning, or any combination thereof.

States of PDN digital model 105 may be represented in some implementations by the embeddings generated by embedding module 106. In some such implementations, training module 112 may train embedding ML models 107 using various similarity learning techniques such that semantically, structurally, and/or contextually similar states of PDN digital model 105 may be similar to (e.g., “close to”) each other in embedding space. Similarity measures in embedding space may be measured using techniques such as Euclidean distance, cosine similarity, dot product, etc. In some implementations, training module 112 may employ similarity learning techniques such as triplet loss, locality-sensitive hashing, etc.

One source of training data for prediction ML models 107 and/or 109 is historical distribution data that indicates attributes of various aspects of PDN digital model 105 (as a proxy for the real-world package distribution network) at different points of time, such as before/after past traversal(s) of packages between various locations. As an example, a state or snapshot of all or part of PDN digital model 105, including observed attributes of various waypoints, lanes, distribution channels, etc., may be obtained prior to or contemporaneously with the beginning of a package's journey from an origin to a destination, at various points during the package's journey, and/or at the end of the package's journey. These states/snapshots may be used by training module 112 as training data (e.g., time series training data) to map various states of PDN digital model 105 to various other states of PDN digital model 105, and hence, train one or more prediction ML models 109. Intuitively, by “learning” how PDN digital model 105 evolves over time given various ground truth contextual data, prediction ML models 109 may become tuned to predict how PDN digital model 105 is likely to evolve in the future. These predictions may be used by evaluation module 110 to help users determine how to ship packages across the real-world package distribution network.

In some implementations, training module 112 may employ training techniques such as reinforcement learning (RL) to train one or more prediction ML prediction models 109 to generate probability distributions over a plurality of candidate actions. These candidate actions, which collectively may form a continuous or discrete action space, may include candidate pathways for a package to be transported across the real-world package distribution network represented by PDN digital model 105, and/or constituent components of those candidate pathways. The probabilities associated with these candidate actions may be probabilities that those actions should be selected (e.g., that they will result in a successful outcome), probabilities that if selected will result in the package arriving at its destination undamaged, in a timely manner, etc.

In some implementations, a probability may be predicted for each candidate pathway as a whole, e.g., based on aggregate probabilities of its constituent components and/or based on a single probability generated from a single embedding representing the whole candidate pathway. Additionally or alternatively, in some implementations, an RL-trained prediction ML model 109 may be applied iteratively to a sequence of constituent components of PDN digital model 105 to generate a whole candidate pathway. At each iteration, a probability distribution may be generated over candidate “next hops” of PDN digital model 105, such as edges of the graph that can be traversed from the current node, etc.

In some implementations, training module 112 may train a prediction ML model 109 as follows. Snapshots of all or part of PDN digital model 105 may be captured over time to form a time series of snapshots. Each snapshot may include presently observed values of various attributes (e.g., “ground truth”) of various lanes/distribution channels, waypoints, etc. Each snapshot may include other metadata as well, such as date, season (which dictates climate and hence, travel conditions), time-of-day, current holidays (which can heavily impact shipping), and so forth. Training module 112 (or inference module 108) may iteratively process the time series of snapshots (and metadata if applicable) to generate predictions of future (e.g., next step) snapshots. The predicted snapshots (or aspects thereof) may then be compared to subsequently observed ground truth to generate errors. Based on these errors, training module 112 may train the prediction ML model 109, e.g., using techniques such as gradient descent, back propagation, cross entropy, etc. Once trained, the prediction ML model 109 may be used subsequently to process a current snapshot of PDN digital model 105 to predict future snapshot(s) or aspects thereof that are usable in downstream computer processes (e.g., logistics application 124).

The real-world package distribution network represented by PDN digital model 105 may be vast, with large numbers of distribution channels, waypoints, lanes, etc., which may make training and/or inference computationally expensive. Moreover, many attributes of the real-world package distribution network may have limited influence on a given candidate pathway, e.g., because of geographic remoteness. Accordingly, in various implementations, training module 112 and/or inference module 108 may take various actions to reduce the amount of computational resources used to perform their respective roles.

For example, in some implementations, training module 112 may obtain snapshots of less than the entire PDN digital model 105 and train on these snapshots. In some such implementations, random portions of PDN digital model 105 may be omitted, masked, and/or populated with random values before training module 112 makes its predictions. To the extent these predictions (made from less-than-complete snapshots) differ from subsequent ground truth, training module 112 can train prediction ML model 109. This may result in prediction ML model 109 being usable, e.g., by inference module 108, to make accurate predictions with less than comprehensive input data. For example, it may not be practicable for an individual entity such as a carrier to obtain and/or process a comprehensive snapshot of a worldwide package distribution network every time a customer asks the carrier to bid on shipping a package. However, the carrier may be better able to obtain a limited snapshot of a portion of PDN digital model 105, such as a portion that includes lanes, distribution channels, and/or waypoints that are used by and/or usable by the carrier, or that influence those lanes, distribution channels, and/or waypoints used by the carrier. If prediction ML model 109 is trained as described above using incomplete and/or partially masked snapshots of PDN digital model 105, then inference module 108 may be able to generate reasonably or even highly accurate predictions using less-than-comprehensive data that is, for instance, localized to the carrier.

In other implementations, prediction ML model(s) 109 may be trained or “fine-tuned” for a particular region, for the perspective of a particular carrier, etc. In those cases, when obtaining snapshots of PDN digital model 105, at least some portions that are less relevant and/or directly influential to that particular region/carrier may be deliberately (as opposed to randomly) omitted, masked (e.g., with zeroes, null values, etc.), populated with random values, etc. For example, if prediction ML model 109 is being trained for a particular country or continent, snapshots obtained of PDN digital model 105 may be limited to distribution channels/lanes/waypoints within that country or continent, and other channels/lanes/waypoints outside of the country or continent may be omitted, masked, randomly populated, etc.

Referring back to FIG. 1, UX module 114 may be configured to provide an interface such as an application programming interface (API) to which applications such as logistics application 124 can communicatively couple. In various implementations, UX module 114 may receive user input identifying data such as one or more candidate origins of a package to be sent, as well as one or more candidate destinations for the package. For instance, there may be multiple different warehouses, manufacturing facilities, etc., that may currently have an inventory of a particular component to be shipped. Any of these locations may be a candidate source of the package containing (or comprising) the component. Likewise, in some situations, there may be more than one candidate destination to ship a component, such as more than one manufacturing or assembly facility that can incorporate the component into a larger system, machine, vehicle, etc.

In some implementations, UX module 114 may receive/obtain inferences and/or predictions generated by inference module 108 and/or evaluation module 110. Based on these data, UX module 114 may generate digital and/or paper messages that include, for instance, recommendations as to how a product/component should be transported across the real-world distribution network given its current state represented by PDN digital model 105. Additionally or alternatively, UX module 114 may generate commands that are transmitted to particular carriers to transport a package between two or more waypoints.

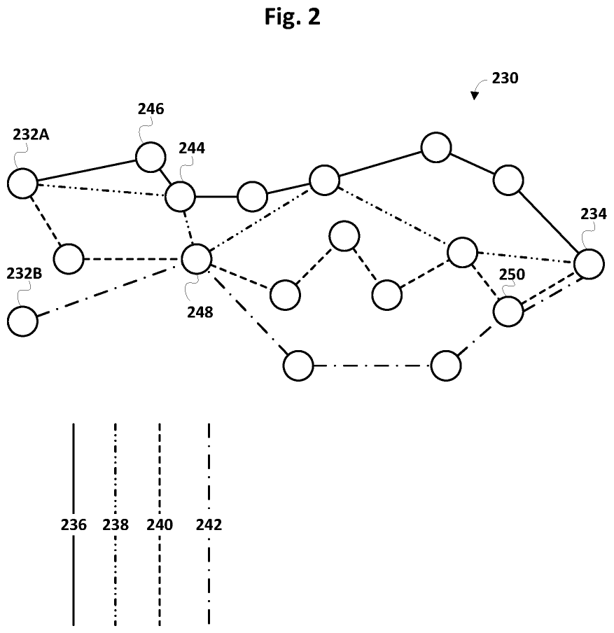

FIG. 2 schematically depicts an example graph 230 that may form part of PDN digital model 105. Nodes of graph 230 may represent intermediate waypoints of the real-world package distribution network and edges of graph may represent distribution channels or lanes between the waypoints. In this example, assume that a user has signified, e.g., using logistics application 124, that they wish to transport a package from one of two candidate origins 232A, 232B to one destination 234. Four candidate pathways, 236, 238, 240, 242 have been identified between candidate origins 232A, 232B and destination 234. While not shown in FIG. 2 for purposes of brevity and simplicity, it should be understood that graph 230 may be only a small subset of a much larger graph (not depicted) of PDN digital model 105.

It can be seen from graph 230 that different candidate pathways may pass through the same intermediate waypoints at different times. Node 244, for instance, is traversed by both path 236 (solid line) and path 238 (dash-dot-dot-dash line). This may represent two different ways to transport packages from first source 232A to the waypoint represented by node 244 (e.g., ingress of a container port). Path 236 may pass first through node 246, which may represent, for instance, a mail handling facility, before arriving at node 244. By contrast, path 238 may directly connect the source 232A to node 244. Similarly, node 248 is traversed by paths 238, 240, and 242.

An example where two edges connect a pair of nodes is seen between node 250 and destination node 234. This may represent, for instance, two different physical pathways between the locations represented by those nodes, such as two different roads. This may alternatively represent, for instance, two different carriers that are equipped to carry packages between the locations represented by nodes 250 and 234. Each carrier may have different operational capabilities, and hence, each edge between nodes 250 and 234 may have different attributes.

In various implementations, data indicative of graph 230 may be processed, e.g., by embedding module 106 using one or more embedding ML models 107, to generate embeddings that represent, for instance, the state of graph 230 (or PDN digital model 105 as a whole) at particular point(s) in time. These embeddings may then be processed, e.g., by inference module 108 using one or more prediction ML models 109, to generate various predictions about individual nodes and/or edges, e.g., currently or in the future. Based on these predictions, evaluation module 110 may cooperate with UX module 114 to provide various recommendations to a user of logistics application 124, and/or to automatically initiate selection and/or transport of a package across one of candidate pathways 236, 238, 240, 242.

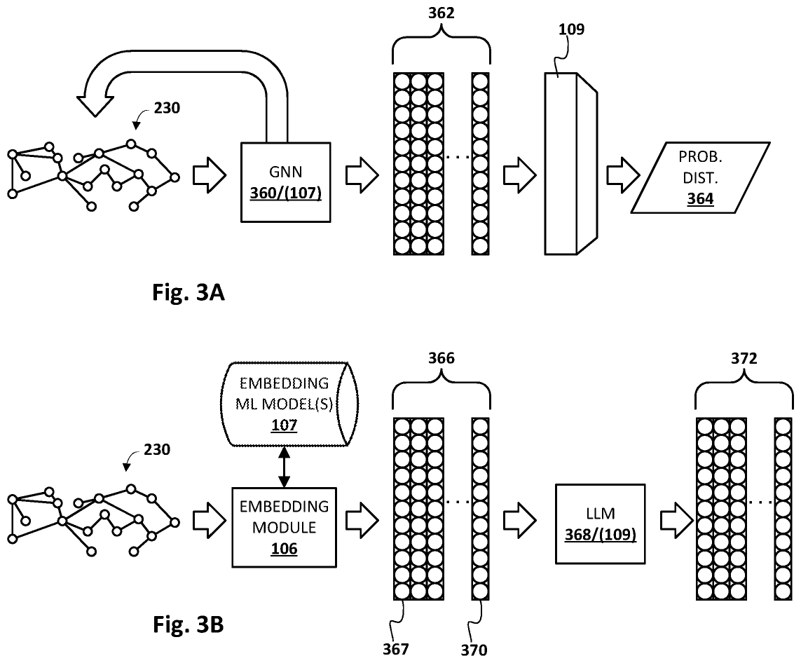

FIGS. 3A-B schematically depict different non-limiting examples of how graph 230 can be processed in order to generate various predictions and/or inferences that can then be leveraged to facilitate efficient, low risk, timely, and/or low cost transport of a package across the real-world package distribution network represented by PDN digital model 105. In FIG. 3A, graph 230 is processed, e.g., by inference module 108 (not depicted), based on a GNN 360, which may be an embedding ML model 107. As noted previously, application of GNN 360 to graph 230 may include iterative message passing between nodes of graph 230 to generate, e.g., at each node (and/or edge), semantically rich representations (e.g., embeddings) of not only the waypoint/lane/distribution channel represented by the node, but of its relationships to its neighbors. The more iterations of message passing, the more information from increasingly distance nodes is incorporated into a given node's representation/embedding.

In some implementations, the nodes' representations may be aggregated or combined, e.g., by embedding module 106 using concatenation, averaging, etc., to generate data 362 as an aggregate embedding that represents the entire graph 230. Additionally or alternatively, in some implementations, the nodes' representations may be linearized in accordance with their relationships in graph 230 to generate, as data 362, a sequence of embeddings (or more generally, “tokens”).

In various implementations, data 362 indicative of the nodes' representations may be processed, e.g., by inference module 108, using a prediction ML model 109. As indicated by the arrows, this processing may yield, in some implementations, a probability distribution 364. In various implementations, probability distribution 364 may include probabilities associated with each of candidate paths 236, 238, 240, 242. These probabilities may be, for instance, probabilities that each candidate path should be selected compared to the others, probabilities that each candidate path with satisfy a given constraint, etc. In some implementations, each probability of probability distribution 364 may represent a probability that traversal of a payload across a respective distribution channel will satisfy a temporal constraint. For example, there may be a need to get the payload to destination 234 within a certain time interval or before a particular date. Or, there may be a requirement that the overall travel time be less than some threshold, e.g., if the payload is perishable. Additionally or alternatively, the constraint may be a risk of payload loss constraint, wherein the risk of damaging or losing the payload on a given candidate pathway cannot exceed some threshold. These constraints need not be mutually exclusive. For instance, if a package is perishable, then the risk of loss may be directly related to the temporal constraint.

FIG. 3B is similar to FIG. 3A in some respects. In this example, graph 230 is processed by embedding module 106 using embedding ML model(s) 107 to generate one or more tokens 366. Token(s) 366 may be continuous or discrete embeddings in some cases, and may or may not be similar to data 362 indicative of the nodes' representations in FIG. 3A. In some implementations, token(s) 366 may include a sequence of tokens, each being an embedding representing an aspect of graph 230, such as a node, an edge, etc.

In some implementations, a first token 367 and/or a last token 370 may be provided to “condition” or “prompt” a large language model (LLM) 368 (which in some cases may be a transformer that is part of prediction ML models 109) to process other tokens 366 to make a prediction that is aligned with, for instance, a user request. Suppose a user wants to transport a package from a particular origin (e.g., a manufacturer, warehouse, etc.) to a particular destination (e.g., customer, assembly plant, etc.). First token 367 may represent the particular origin of the package identified by the user, e.g., as an embedding of a node or edge of graph 230 (e.g., 232A, 232B) that represents the particular origin. Similarly, last token 370 may represent the particular destination for the package identified by the user, e.g., as an embedding of a node (e.g., 234) or edge of graph 230 that represents the particular destination. If there are multiple candidate sources/origins or destinations, they may be included as multiple first/last tokens in some implementations.

Additionally or alternatively, first token 367 (or other tokens preceding or following first token 367) may semantically represent specific user commands. For example, a user may issue a natural language request, “Find me the safest way to ship 3,000 doses of insulin from Minnesota to Kentucky.” This natural language request may be processed, e.g., by embedding module 106 using one or more natural language processing (NLP) embedding models 107, to generate a semantically rich embedding (e.g., a token) that represents the user's intent. This intent may be used, along with the other tokens formulated from graph 230 (and hence, from PDN digital model 105), to identify and/or select from candidate pathways (e.g., 236, 238, 240, 242) across the real-world package distribution network. In particular, the token(s) representing the user's request, particularly the word “safest,” may prompt LLM 368 to make prediction(s) that are geared towards satisfying a risk of payload loss constraint, as opposed to say, a constraint that the insulin arrive in Kentucky by a particular date.

LLM 368 may be applied, e.g., by inference module 108 (not depicted in FIG. 3B), to input tokens 366 to generate one or more sequences of output tokens 372. Output tokens 372 may represent various types of predictions, depending on how LLM 368 was trained, conditioned, etc. In some implementations, output tokens 372 may represent a sequence of hops (e.g., nodes and/or edges) across graph 230 (or PDN digital model 105 as a whole) that collectively define a suitable pathway across the real-world package distribution network. In some such implementations, beam searching may be performed with a beam width that is greater than one, e.g., to identify multiple different candidate pathways across the real-world package distribution network. Additionally or alternatively, in some implementations, each output token of sequence 372 may represent a probability distribution over “next hops” available to a current hop of graph 230 (or of PDN digital model 105 as a whole). One or more candidate pathways across graph 230 may be generated, selected, ranked, etc., based on these probability distributions.

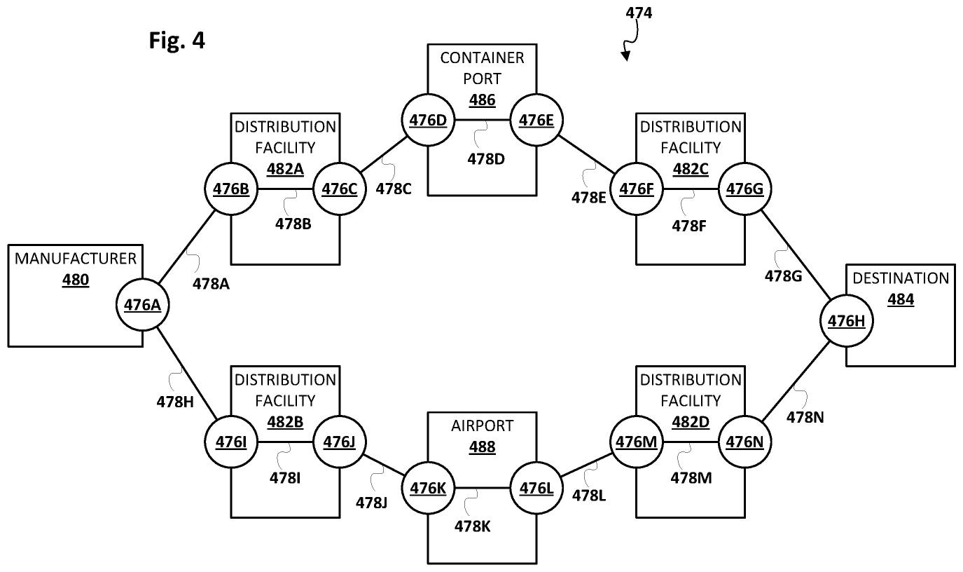

As noted previously, PDN digital model 105 may include various types of graphs having nodes and edges that represent various locations, waypoints, lanes, etc. FIG. 4 schematically demonstrates one non-limiting example of how PDN digital model 105 may be formed as a digital data structure in memory, and in particular, how nodes and edges may be used to represent a small portion of a real-world package distribution network. The digital data structure demonstrated by FIG. 4 may be used when, for instance, edges represent lanes/distribution channels and therefore have one or more assignable attributes (e.g., capacity, throughput, latency/delay, risk of payload loss, traffic). In this example, nodes are used to represent simple waypoints between edges. In other implementations, e.g., in which edges do not have assignable attributes, nodes may be used to represent lanes/distribution channels and edges may represent waypoints. For purposes of demonstration and explanation as to how PDN digital model 105 may be generated in memory, this example includes two candidate pathways (one at top, one at bottom) between a source (480) and a destination (484); but this is not meant to be limiting. In a real-world application, there would typically be myriad candidate pathways between any source and destination, and at least some of these candidate pathways would have overlapping portions (as depicted in FIG. 2).

A graph 474 is depicted that includes a plurality of nodes 476A-N and a plurality of edges 478A-N. Starting at left, a manufacturer 480 may be a source of a package a user operating logistics application 124 wishes to send to a destination 484. Alternatively, the user could request that the package be sent from another source, such as a warehouse having inventory of the good or component of the package the user wishes to send to destination 484. In any case, an egress waypoint (e.g., representing a loading dock of manufacturer 480) may be represented by node 476A.

From manufacturer 480, there are two distribution facilities to choose from, 482A and 482B. Following edge 478A (which may represent a lane/distribution channel such as a road or rail), first distribution facility 482A includes an ingress waypoint (e.g., an intake loading dock) represented by node 476B and an egress waypoint (e.g., another loading dock from which outgoing packages are loaded) represented by node 476C. In between, edge 478B represents a lane/distribution channel within distribution facility 482A. Distribution facility 482A may have various operational capabilities such as capacity, throughput, traffic, etc., which may be affected by availability (or lack thereof) of labor, surplus inventory, etc. For example, if there are insufficient staff (e.g., due to a strike, lack of job applicants, etc.), there may be a delay for a package to make its way through distribution facility 482A. These operational capabilities may be assigned as attributes to edge 448B, such that edge 448B represents the operational capabilities of distribution facility 482A.

Following edge 478C (e.g., representing a road, rail, waterway, etc.), the next stop for the package may be a container port 486 on a body of water or waterway. As with distribution facility 482A (and other facilities depicted in FIG. 4), container port 486 may have an ingress (e.g., a receiving area) that is represented by node 476D and an egress location that is represented by node 476E. In a container port such as 486, an egress represented by node 476E may include, for instance, a loading area for multiple container ships, or even an individual container ship. Thus, while not depicted in FIG. 4, in some cases where there are multiple container ships, container port 486 may have multiple different egress nodes, each corresponding to a respective dock (and each dock/container ship may have its own operational capabilities as well, e.g., depending on the entity that runs it). In between nodes 476D and 476E, edge 478D may represent the attributes and/or operational capabilities of container port 486, e.g., from intake to a particular dock. For example, edge 478D may include a latency attribute that represents how long (e.g., on average) it takes for an incoming package to be loaded into a container, and for that container to be loaded onto a container ship.

From egress node 476E (e.g., once the package's container is loaded onto a ship), edge 478E may represent a waterway, such as a shipping lane across a body of water (e.g., a gulf, sea, ocean, etc.). Thus, edge 478E may have attributes that are pertinent to waterways and the impact or influence they'll have on a package's travels. For instance, edge 478E may include exogenous attributes such as speed(s), direction(s), and/or trajectory (ies) of currents, climate attributes (e.g., storms), surface conditions (e.g., height of waves), and so forth. Likewise, edge 478E may include other attributes such as distance, capacity, throughput, latency, traffic, risk of payload loss, etc.

The waterway represented by edge 478E leads to an ingress node 476F of another distribution facility 482C. Like distribution facility 482A, distribution facility 482C includes its own internal edge 478F that may include attributes representing operational capabilities of distribution facility 482C. An egress node 476G of distribution facility 482C may be coupled with an edge 478G representing a lane to an ingress node 476H (e.g., a receiving area, loading dock, etc.) of destination 484. Like other edges 478 in FIG. 4, edge 478G may include its own attributes, such as distance, capacity, throughput, latency, traffic, risk of payload loss, etc.

In sum, the top half of graph 474 in FIG. 4 represents a first candidate pathway from manufacturer 480 to destination 484 that includes nodes 476A-H and edges 478A-G. The bottom half of FIG. 4 represents an alternative candidate pathway from manufacturer 480 to destination 484 that includes nodes 476A, 476I-N, and 476H, as well as edges 478H-N. The alternative candidate pathway traverses through two different distribution facilities 482B and 482D, as well as through an airport 488, in contrast to the first top candidate pathway, which traverses through container port 486 as described above.

As was the case with facilities 482A, 482C, and with container port 486, edges 478I, 478K, and 478M represent operational capabilities of the respective facilities. For instance, edge 478K may represent operational capabilities of airport 488, such as how long (e.g., on average, median, etc.) it takes to unload a package from the location represented by ingress node 476K and load it onto an appropriate airplane (e.g., represented by egress node 476L). As with container port 486, most airports may include, at any given point in time, multiple airplanes and/or loading docks and/or gates. Thus, while only a single egress node 476L is depicted on airport 488 in FIG. 4, there may be multiple different egress nodes 476L. Moreover, packages may arrive at airport 488 on one airplane, be unloaded, and then be loaded on a different airplane. Accordingly, there may be multiple ingress nodes of airport 488 as well (the same may be true for container port 486 or any other facility depicted in FIG. 4 or elsewhere herein).

Using components such as those depicted in FIGS. 1-4, and in particular, based on those components' current observed attributes, it is possible to predict future attributes of various lanes, distribution channels, and/or waypoints. Suppose personnel at distribution facility 482A are on strike, causing congestion and delay at distribution facility 482A. This congestion and/or delay may be represented as attributes of edge 478B. This also may be usable to predict future attributes of other facilities of the real-world package distribution network that may be impacted by this congestion or delay. For example, a prediction may be made, e.g., by inference module 108 based on one or more prediction ML models 109 applied to embeddings representing graph 474, that edge 478D of container port 486 will experience delays as well. This may be because container ship(s) at container port 486 are held up waiting for packages from distribution facility 482A before they can embark down the waterway represented by edge 478E.

As an alternative working example, suppose there are delays at distribution facility 482B that result in delays being predicted (e.g., by inference module 108) at edge 478K of airport 488, e.g., because one or more airplanes are held up waiting for packages from distribution facility 482B. Suppose further that, unlike the previous example, distribution facility 482A is running smoothly, and therefore, container port 486 (and edge 478D) is predicted to not experience significant internal delays.

All other things considered, shipping a package via container ship normally would take longer than shipping a package via airplane. However, given the delay at distribution facility 482B upstream of airport 488, it may be the case that shipping the package along the top candidate pathway through container port 486 may be quicker than shipping the package through the bottom pathway through airport 488. Consequently, a user operating logistics application 124—especially where the user has signaled that timing is important—may receive a recommendation to ship the package via the top pathway, or the top pathway may be ranked higher than the bottom pathway. Or, in some implementations where a confidence that the package will reach destination 484 via the top candidate pathway satisfies a temporal constraint imposed by the user, a digital or paper shipping order may be generated automatically, and the shipment may be performed automatically as well.

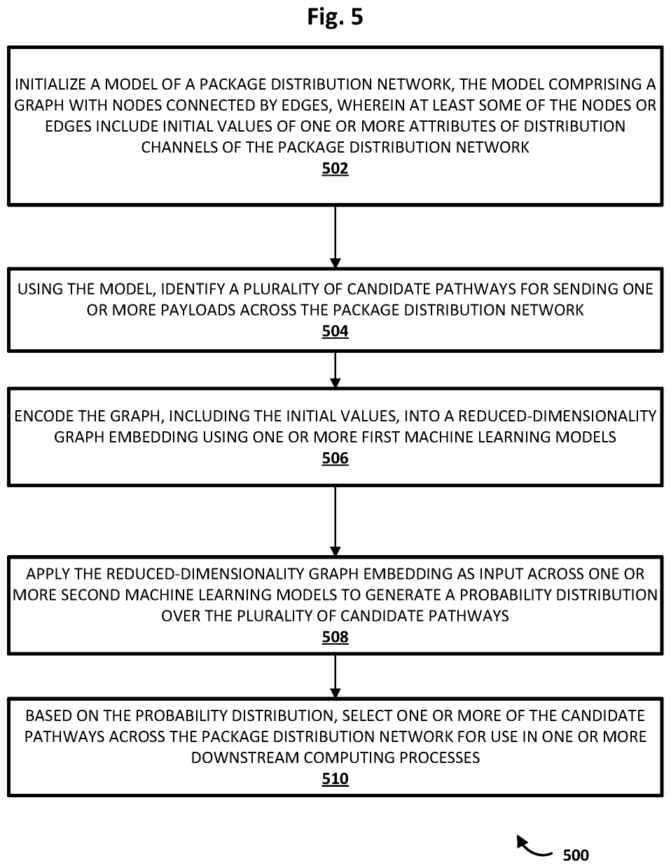

FIG. 5 is a flowchart illustrating an example method 500 of performing selected aspects of the present disclosure, in accordance with various implementations. For convenience, the operations of the flow chart are described with reference to a system that performs the operations. This system may include various components of various computer systems, such as one or more components of package distribution system 102. Moreover, while operations of method 500 are shown in a particular order, this is not meant to be limiting. One or more operations may be reordered, omitted or added.

At block 502, the system, e.g., by way of SIM module 104, may initialize a model of a package distribution network, such as PDN digital model 105, in a digital computing system. As noted elsewhere, in some implementations, PDN digital model 105 may include a graph (e.g., 230, 474) with nodes connected by edges. At least some of the nodes or edges may be populated with initial values of one or more observed (or hypothetical, or predicted) attributes of distribution channels of the package distribution network.

Using the model, at block 504, the system may identify a plurality of candidate pathways for sending one or more payloads across the package distribution network, e.g., from one or more origins/sources identified by a user of logistics application 124 to one or more destinations identified by the user. In some implementations, one or more of the candidate pathways may be identified using techniques such as depth-first searching, Dijkstra's algorithm, etc., e.g., based on constraints such as the paths have less than x hops. In some implementations, Dijkstra's algorithm may be applied iteratively to accumulate some desired count (e.g., three, five, ten) of the shortest paths (e.g., based on hops, distances, etc.) between the origin(s) and destination(s). At each iteration, the next shortest remaining path may be identified and added to the accumulated list of shortest paths.

At block 506, the system, e.g., by way of embedding module 106, may encode the graph, including the initial values, into a reduced-dimensionality graph embedding (e.g., 362, 366) using one or more embedding ML models 107, such as a GNN, LLM (e.g., by linearizing the nodes and edges into a sequence of tokens), etc. At block 508, the system, e.g., by way of inference module 108, may apply the reduced-dimensionality graph embedding as input across one or more prediction ML models 109 to generate a probability distribution (e.g., 364, 372) over the plurality of candidate pathways, and/or over constituent components of the candidate pathways such as waypoints, individual lanes between waypoints, etc.

Based on the probability distribution, at block 510, the system, e.g., by way of evaluation module 110, may select one or more of the candidate pathways across the package distribution network for use in one or more downstream computing processes. In some implementations, evaluation module 110 may select the candidate path(s) such that traversal of a payload across the selected path(s) is most likely (e.g., based on probability distribution(s) calculated at block 508) to satisfy some constraint. These constraints may include, for instance, a temporal constraint such as a maximum travel time, arrival deadline, a risk of payload loss constraint, etc. With an arrival deadline, it is not always the case that the constraint is for the package to arrive on or before the arrival deadline. In some cases, it may be desirable to ensure that a package will not arrive until after an arrival deadline. For instance, if a destination's inventory is going to be at capacity until some date (e.g., which some of that inventory will be shipped away), it may be preferable that a package does not arrive at the destination until after that date. Alternatively, if storing a product or component is costly (medicines that require super-cooling, for instance), an entity that is associated with the destination may not want to receive the product or component any earlier than necessary.

The one or more downstream computing processes may take any number of forms and serve any number of purposes. In some implementations, a downstream computing process may be a computing process such as logistics application 124 for selecting one or more distribution channels between an origin and a destination. For example, a ranked plurality of candidate pathways may be presented to a user of logistics application 124, e.g., with pros and cons of each candidate conveyed to the user as annotations. Based on these rankings and/or annotations, the user may select the candidate path that will best suit their needs for transporting a package from an origin to a destination.

In some implementations, the downstream computing process(es) may include a server application such as a web service that is configured to automate aspects of transporting packages across a real-world distribution network. The server application may be configured to, for instance, automatically generate one or more digital (or paper) work orders specifying that a package be shipped from an origin to a destination along a particular candidate path selected as described previously. In some implementations, a digital work order may include commands and/or other data that will trigger automated systems to physically move a package into the candidate pathway for shipment. For instance, one or more autonomous or semi-autonomous warehouse robots may be controlled based on a digital work order to cause a product to be inserted (e.g., packaged, marked with a destination address, etc.) into the selected candidate pathway across the real-world package distribution network.

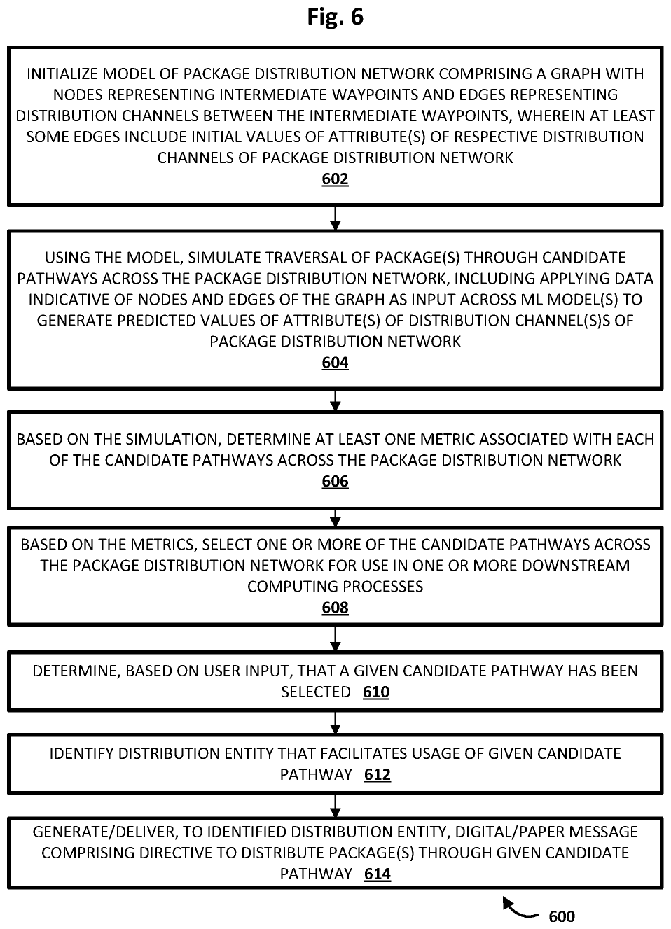

FIG. 6 is a flowchart illustrating an example method 600 of performing selected aspects of the present disclosure, in accordance with various implementations. For convenience, the operations of the flow chart are described with reference to a system that performs the operations. This system may include various components of various computer systems, such as one or more components of package distribution system 102. Moreover, while operations of method 600 are shown in a particular order, this is not meant to be limiting. One or more operations may be reordered, omitted or added.

At block 602, the system, e.g., by way of SIM module 104, may initialize a PDN digital model 105 in a digital computing system, similar to block 502 of FIG. 5. In some implementations, PDN digital model 105 may include a graph with nodes representing intermediate waypoints of the package distribution network and edges representing distribution channels between the intermediate waypoints. At least some of the edges may be initialized with initial values of one or more attributes of the respective distribution channels of the package distribution network. In some implementations, the initial values may include, for instance, capacity, throughput, traffic, latency, distance, etc. of the distribution channels of the package distribution network.

Using the model, at block 604, the system, e.g., by way of SIM module 104 and/or inference module 108, may simulate traversal of one or more packages through a plurality of candidate pathways across the package distribution network. In some implementations, the simulating may include inference module 108 applying data indicative of nodes and edges of the graph—including the initial values—as input across one or more embedding and/or prediction ML models 107, 109 to generate predicted values of one or more attributes of the distribution channels of the package distribution network. One or more of the machine learning models may have been trained, e.g., by training module 112, based on historical package distribution data to generate output indicative of predicted distribution channel attributes. In some implementations, the predicted values of one or more attributes of the distribution channels may include a capacity of one of the distribution channels and/or a risk of payload loss or damage associated with one of the distribution channels.

Based on the simulating at block 604, at block 606, the system, e.g., by way of evaluation module 110, may determine at least one metric associated with each of the candidate pathways across the package distribution network. In various implementations, the metric associated with each candidate pathway may include, for instance, a predicted time interval to traverse the one or more packages through the candidate pathway, a predicted risk of loss of the one or more packages (e.g., payload loss) in transit, and so forth.

Based on the metrics determined at block 606, at block 608, the system, e.g., by way of evaluation module 110 and/or UX module 114, may select one or more of the candidate pathways across the package distribution network for use in one or more downstream computing processes, which may be the same as or similar to those downstream processes described previously. In some implementations, the operations of block 608 may include ranking the plurality of candidate pathways based on the metrics.

In some implementations, at block 610, the system, e.g., by way of UX module 114, may determine, based on user input received at the digital computing system or another digital computing system, that a given candidate pathway has been selected by a user of logistics application 124. At block 612, package distribution system 102 may identify a distribution entity (e.g., a carrier) that facilitates usage of the given candidate pathway. At block 614, package distribution system 102 may automatically generate and transmit, to the identified distribution entity, a digital message comprising a directive or command to distribute the one or more packages through at least a portion of the given candidate pathway. In other implementations, package distribution system 102 may automatically print correspondence including the directive or command to distribute the one or more packages, including printing a mailing label, and cause it to be physically delivered to the identified distribution entity. In some implementations, the operations of block 614 may be performed conditionally, e.g., based on a confidence or probability of the given candidate pathway satisfying some threshold.

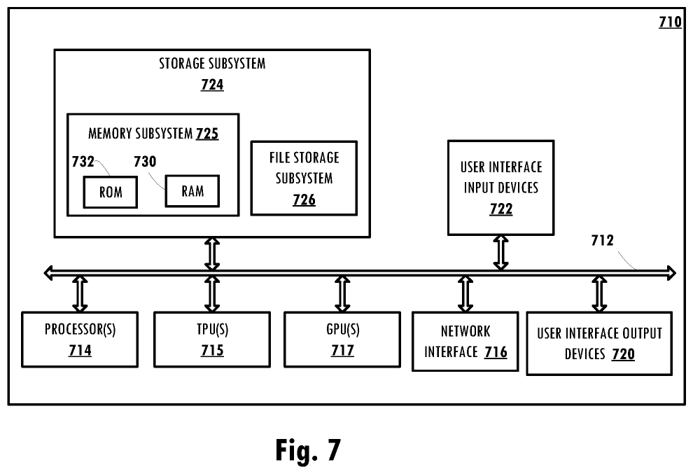

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. As shown in FIG. 7, in some implementations, computing device 710 may include additional logic that is optimized for executing machine learning-based computations, such as one or more tensor processing units (“TPUs”) 715 and/or one or more graphics processing units (“GPUs”) 717.

The peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods of FIGS. 5-6, as well as to implement various components depicted in FIGS. 1 and 3.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by a digital computing system, comprising:
initializing a model of a package distribution network in the digital computing system, the model comprising a graph with nodes representing intermediate waypoints of the package distribution network and edges representing distribution channels between the intermediate waypoints, wherein at least some of the edges include initial values of one or more attributes of the respective distribution channels of the package distribution network;
using the model, simulating traversal of one or more packages through a plurality of candidate pathways across the package distribution network, wherein the simulating comprises applying data indicative of nodes and edges of the graph as input across one or more machine learning models to generate predicted values of one or more attributes of the distribution channels of the package distribution network, wherein the data indicative of nodes and edges includes the initial values;
based on the simulating, determining at least one metric associated with each of the candidate pathways across the package distribution network; and
based on the metrics, selecting one or more of the candidate pathways across the package distribution network for use in one or more downstream computing processes.

2. The method of claim 1, wherein the one or more downstream computing processes includes causing output indicative of the one or more selected candidate pathways to be rendered at one or more output devices.

3. The method of claim 2, further comprising:
determining, based on user input received at the digital computing system or another digital computing system, that a given candidate pathway has been selected;
identifying a distribution entity that facilitates usage of the given candidate pathway; and
automatically generating and transmitting, to the identified distribution entity, a digital message comprising a directive to distribute the one or more packages through at least a portion of the given candidate pathway.

4. The method of claim 1, further comprising ranking the plurality of candidate pathways based on the metrics.

5. The method of claim 1, wherein the predicted values of one or more attributes of the distribution channels include a capacity of one of the distribution channels.

6. The method of claim 1, wherein the predicted values of one or more attributes of the distribution channels include a risk of payload loss or damage associated with one of the distribution channels.

7. The method of claim 1, wherein the initial values include a capacity of one of the distribution channels of the package distribution network.

8. The method of claim 1, wherein one or more of the machine learning models comprises a transformer model, and the method further comprises, prior to the applying, linearizing at least a portion of the graph into a sequence of tokens representing nodes and edges of the graphs.

9. The method of claim 1, wherein one or more of the machine learning models comprises a graph neural network.

10. The method of claim 1, wherein the metric associated with each candidate pathway comprises a predicted time interval to traverse the one or more packages through the candidate pathway.

11. The method of claim 1, wherein the metric associated with each candidate pathway comprises a predicted risk of loss of the one or more packages in transit.

12. The method of claim 1, wherein one or more of the machine learning models has been trained based on historical distribution data to generate output indicative of predicted distribution channel attributes.

13. A method implemented using a digital computing system, comprising”
initializing a model of a package distribution network in the digital computing system, the model comprising a graph with nodes connected by edges, wherein at least some of the nodes or edges include initial values of one or more attributes of distribution channels of the package distribution network;
using the model, identifying a plurality of candidate pathways for sending one or more payloads across the package distribution network;
encoding the graph, including the initial values, into a reduced-dimensionality graph embedding using one or more first machine learning models;
applying the reduced-dimensionality graph embedding as input across one or more second machine learning models to generate a probability distribution over the plurality of candidate pathways; and
based on the probability distribution, selecting one or more of the candidate pathways across the package distribution network for use in one or more downstream computing processes.

14. The method of claim 13, wherein each probability of the probability distribution represents a probability that traversal of one or more of the payloads across a respective distribution channel will satisfy a constraint.

15. The method of claim 14, wherein the constraint comprises a temporal constraint.

16. The method of claim 14, wherein the constraint comprises a risk of payload loss constraint.

17. The method of claim 13, wherein the one or more downstream computing processes comprises a computing process for selecting one or more distribution channels between an origin and a destination.

18. The method of claim 13, wherein one or more of the first machine learning models comprises a graph neural network.

19. The method of claim 13, wherein the nodes represent waypoints of the package distribution network and edges represent distribution channels between the waypoints.

20. The method of claim 13, wherein the edges represent waypoints of the package distribution network and the nodes represent distribution channels between the waypoints.
